(19) United States
(12) Patent Application Publication
(10) Pub. No.: US 2012/0054007 A1
(43) Pub. Date: Mar. 1, 2012

(54) APPARATUS AND METHOD FOR PLAYING ADVERTISEMENTS DEPENDING ON USE OF MULTIMEDIA SERVICE

(75) Inventors: Sung-Oh HWANG, Yongin-si (KR); Sergey Nikolayevich Seleznev, Suwon-si (KR)

(73) Assignee: Samsung Electronics Co., Ltd., Suwon-si (KR)

(21) Appl. No.: 13/222,678

(22) Filed: Aug. 31, 2011

(30) Foreign Application Priority Data
Aug. 31, 2010 (KR) 10-2010-0084917

(51) Int. Cl. G06Q 30/00

(52) U.S. Cl. 705/14.4

(57) ABSTRACT

An apparatus and method for playing an advertisement in a device depending on use of a multimedia service are provided. The method includes receiving a user request to execute request specific content; determining whether advertisement enforced-watching information is included in a rights object representing a user's consumption rights for the specific content; executing the specific content; stopping, if the advertisement enforced-watching information is included in the rights object the execution of the specific content according to the advertisement enforced-watching information and providing the advertisement to the user after stopping the execution of the specific content; and resuming the stopped execution of the specific content after providing the advertisement to the user is completed.

### PRIORITY

This application claims priority under 35 U.S.C. §119(a) to a Korean Patent Application filed in the Korean Intellectual Property Office on Aug. 31, 2010 and assigned Serial No. 10-2010-0084917, the entire content of which is incorporated herein by reference.

### BACKGROUND OF THE INVENTION

1. Field of the Invention

The present invention relates generally to an apparatus and method for advertisement services, and more particularly, to an apparatus and method for requiring users to watch advertisements while receiving services or content.

2. Description of the Related Art

A service for providing advertisements to users together with services or content, in order to guarantee a reduction in service or content charges for users, while also guaranteeing authentic advertising effects for the benefit of advertisers, is considered as a promising service for increasing the consumption of multimedia services or content. Although there has been research for developing a scheme that requires users to watch advertisements before enjoying services or content in support of the above-mentioned service, development of such an improved method for requiring users to watch advertisements while enjoying services or content may guarantee advertisers more robust advertising effects. In such a scheme of requiring users to watch advertisements (hereinafter referred to as ‘advertisement enforced-watching scheme’ for short), Digital Rights Management (DRM) technology may be an effective means of enforcement.

DRM, which is a technology used for protecting services or content from illegal distribution and deployment, has been developed to guarantee secure distribution of paid services or paid content and to prevent illegal distribution thereof. DRM may safeguard the rights and interests of service providers or content providers by preventing piracy on services or content, and may comprehensively support all operations from creation of services or content to distribution and management of the services or content, such as billing and payment.

This DRM technology used for protection of services or content allows only the devices of authorized users who have acquired fair-use rights (which may be acquired by paying a predetermined price, for example) to play the services or content. Accordingly, the DRM technology may grant the rights to play services or content to only specific devices, and may also limit the types and the number of content items playable in the devices. If these features of the DRM technology are appropriately utilized, even in a service that provides advertisements together to stimulate consumption of multimedia services or content, it may be possible to provide advertisement consumption models that satisfy the needs of both service providers and users. If users are required to view advertisements while enjoying services or content, such a requirement may increase the exposure of the advertisements.

### SUMMARY OF THE INVENTION

An aspect of embodiments of the present invention provides an apparatus and method for enforcing a user to watch advertisements while being provided with multimedia services or content.

Another aspect of embodiments of the present invention provides an apparatus and method for enforcing a user to watch advertisements while enjoying multimedia services or content in association with DRM technology for protecting multimedia services or content.

Another aspect of embodiments of the present invention provides an apparatus and method for allowing a terminal consuming multimedia services or content to automatically play advertisements so as to reduce the cost for consumption of the multimedia services or content.

In accordance with one aspect of the present invention, a method for playing an advertisement in a device depending on use of a multimedia service is provided. The method includes receiving a user request to execute request specific content; determining whether advertisement enforced-watching information is included in a rights object representing a user's consumption rights for the specific content; executing the specific content; stopping, if the advertisement enforced-watching information is included in the rights object the execution of the specific content according to the advertisement enforced-watching information and providing the advertisement to the user after stopping the execution of the specific content; and resuming the stopped execution of the specific content after providing the advertisement to the user is completed.

In accordance with another aspect of the present invention, an apparatus for playing an advertisement in a device depending on use of a multimedia service is provided. The apparatus includes a multimedia player for delivering, to an agent, a user request to execute specific content, and executing the requested specific content and an associated advertisement under a control of the agent; and the agent for determining whether advertisement enforced-watching information is included in a rights object indicating a user's consumption rights to the specific content upon receiving the execution request for the specific content, executing the specific content on the multimedia player, executing the advertisement on the multimedia player after stopping the execution of the specific content based on the advertisement enforced-watching information if the advertisement enforced-watching information is included in the rights object, and resuming the stopped execution of the specific content after execution of the advertisement is completed.

In accordance with further another aspect of the present invention, a method, performed by a rights issuer issuing a user's consumption rights to a multimedia service, for providing an advertisement to be played on a device, is provided. The method includes receiving a request for specific content from the device; inserting advertisement enforced-watching information in a rights object representing a user's consumption rights to the specific content, the advertisement enforced-watching information including information corresponding to an advertisement to be played during execution of the specific content and information indicating a play time of the advertisement; and transmitting the rights object to the device together with the specific content.

In accordance with yet another aspect of the present invention, a rights issuer for issuing a user's consumption rights for a multimedia service and playing an advertisement on a device is provided. The rights issuer includes a communication unit for receiving a request for specific content from the device; and a processor for, upon receipt of the request for the specific content, inserting advertisement enforced-watching information in a rights object indicating a user's consumption rights to the specific content, the advertisement enforced-watching information including information corresponding to an advertisement to be played during execution of the specific content and information indicating a play time of the advertisement, and controlling the communication unit to transmit, to the device, the rights object together with the specific content.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a diagram illustrating a configuration of a system for providing a multimedia service associated with advertisements according to an embodiment of the present invention;

FIG. 2 is a diagram illustrating a structure of an RO according to an embodiment of the present invention;

FIG. 3 is a diagram illustrating a structure of an RO according to another embodiment of the present invention; and

FIG. 4 is a diagram illustrating an operation between a multimedia player and a DRM agent according to an embodiment of the present invention.

### DETAILED DESCRIPTION OF EMBODIMENTS OF THE INVENTION

Embodiments of the present invention are described in detail as follows with reference to the accompanying drawings. Throughout the drawings, the same drawing reference numerals will be understood to refer to the same elements, features and structures. In the following description, specific details, such as detailed configurations and components, are provided to assist in an overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

Although embodiments of the present invention are described herein with reference to names of various technologies and entities defined in Digital Rights Management (DRM) by Open Mobile Alliance (OMA), which is a mobile broadcast application standards group, use of these names are merely provided for convenience in describing embodiments of the present invention. Accordingly, it will be understood by those of ordinary skill in the art that these names do not limit the scope of the present invention and the proposed apparatus and method may be applied to other similar systems.

According to an embodiment of the present invention, a device determines whether information about advertisement enforced-watching during use of content is present in a Rights Object (RO) for content, determines a play time of the content before the advertisement enforced-watching if the advertisement enforced-watching information is included, performs the advertisement enforced-watching after the play time, and then allows a user to continuously enjoy the content. Another embodiment of the present invention relates to implementing specific requirements on advertisement enforced-watching, in the advertisement enforced-watching during use of the content.

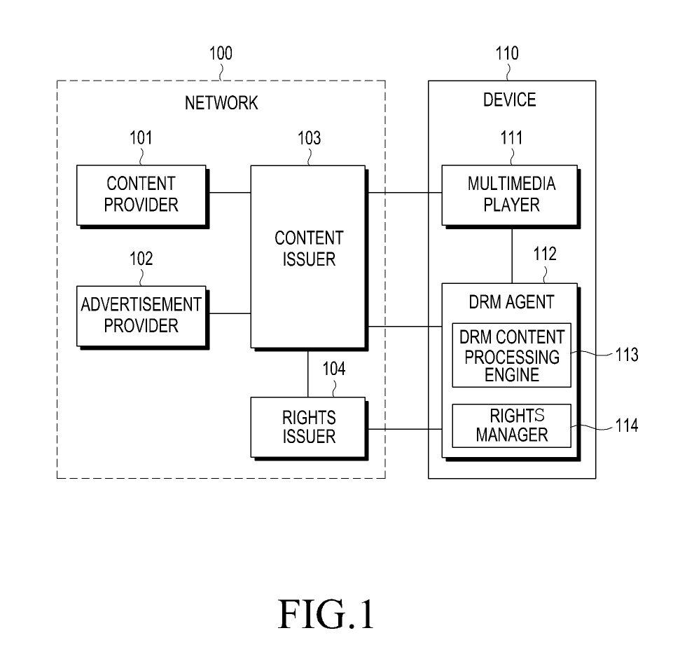

FIG. 1 is a diagram illustrating a configuration of a system for providing a multimedia service associated with advertisements according to an embodiment of the present invention, in which entities related to advertisement enforced-watching are shown in conjunction with DRM technology for protecting multimedia services. Services or content to be protected by the DRM technology may be defined herein as multimedia services. Therefore, while only a content provider and a content issuer are shown in FIG. 1, it will be understood by those of ordinary skill in the art that these entities may also serve as a service provider and a service issuer, respectively. Although the content provider may provide content and/or services, it will be assumed herein that the content provider provides content, for convenience of description.

Referring to FIG. 1, a network 100 includes a Content Provider (CP) 101 for providing content or services, and an Advertisement Provide (AP) 102 for providing advertisements.

The content provider 101 provides content to a Content Issuer (CI) 103, and the advertisement provider 102 provides advertisements to the CI 103.

Operations performed by the CI 103 may include authenticating content in a system to which DRM technology is applied, processing or handling a content request sent by a user, and optionally transmitting, to a device 110 of the user, an encryption key necessary for playing content that is encrypted in accordance with an agreement with a Rights Issuer (RI) 104 and a Rights Object (RO) containing rights to play the content.

The content issuer 103 may create a content & advertisement package by selecting an advertisement(s) to be transmitted along with content, and the content and selected advertisement(s) may be transmitted to the user's device 110 together or individually. According to embodiments of the present invention, in providing configuration information of the content & advertisement package, the content issuer 103 and/or the rights issuer 104 may determine their roles with respect to configuring the content & advertisement package in accordance with a business agreement.

The device 110 includes a multimedia player 111 and a DRM agent 112. The device 110, which may be implemented through hardware, software, or a combination thereof, may refer to any device capable of consuming content that the network 100 provides using DRM technology in accordance with embodiments of the present invention.

The multimedia player 111, which plays content and advertisements, may receive and play content and/or advertisements decrypted by the DRM agent 112. The multimedia player 111 receives, from the DRM agent 112, encrypted content and/or advertisements and a key that can be used to decrypt the encrypted content and/or advertisements, decrypts the received content and/or advertisements and key, and then plays the decrypted content and/or advertisements. The multimedia player 111 may display the advertisements while playing the content.

The DRM agent 112 includes a DRM Content Processing Engine (DCPE) 113 and a Rights Manager (RM) 114. In response to a content request, the DCPE 113 decrypts encrypted content or advertisements and provides the decrypted content or advertisements to the multimedia player 111, and also fetches a key to be used in a decryption process from the RM 114, for a decryption operation.

The RM 114 registers the device 110 in the rights issuer 104, acquires an RO for the content to be played by the device 110, and manages use of the content. Specifically, the RM 114 may acquire and analyze a proposed RO to enforce the user to watch various types of advertisements for a predetermined time while playing the content according to an embodiment of the present invention. In accordance with another embodiment of the present invention, the RM 114 may check an RO of requested content and identify specific requirements associated with an advertisement, if the device 110 must play the advertisement in the middle of playing back the content.

In accordance with alternative embodiments of the present invention, various entities in the network 100 in FIG. 1 may be implemented as different entities or as composite entities performing operations corresponding to more than one of the above-described entities. Similarly, the entities within the device 110 may also be implemented as different entities or as composite entities.

In this system, the rights issuer 104 creates an RO including advertisement enforced-watching information and transmits the created RO to a related device(s) in association with the content issuer 103, depending upon the content to be provided to the device 110 or depending upon the user having requested the content. Although not illustrated, the rights issuer 104 may include a processor for creating an RO and a communication unit for transmitting the RO.

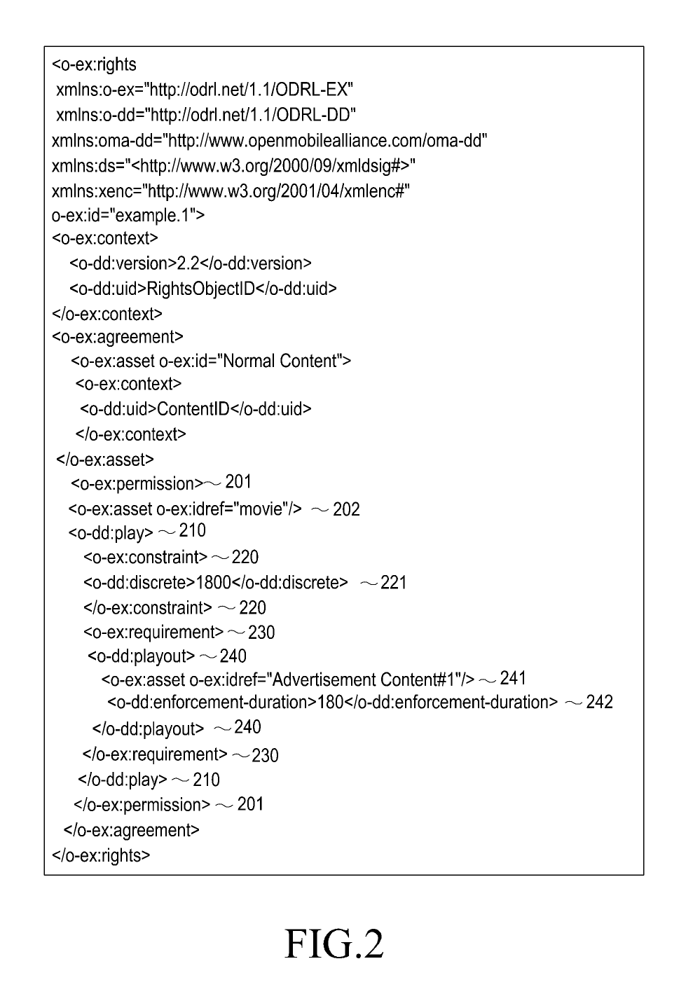

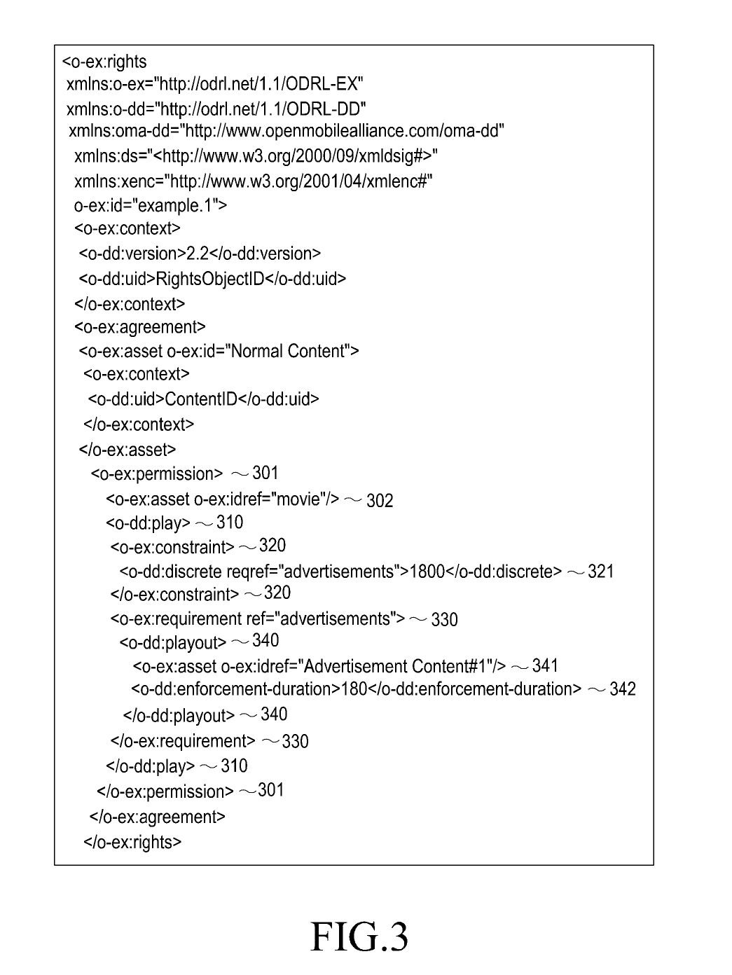

The term ‘advertisement enforced-watching information’, as used herein, refers to information about an advertisement that is required to be played when related content is played, and may include identification information for related content, advertisement play time information, identification information for an advertisement required to be played, and information about advertisement play duration. A structure of the RO is described herein with reference to FIGS. 2 and 3.

FIG. 2 is a diagram illustrating a structure of an RO according to an embodiment of the present invention.

In the structure illustrated in FIG. 2, some structure elements unnecessary for a description of embodiments of the present invention may have been omitted for clarity and conciseness. Details of the OMA DRM RO structure are disclosed in the OMA DRM REL standard.

A ‘rights’ element in FIG. 2, which is a top-level element of the RO, provides an identifier of the RO using a ‘context’ element, and provides rights of the RO and an identifier of content associated with the RO using an ‘agreement’ element.

A ‘permission’ element 201, which is a sub element of the ‘agreement’ element, grants rights to the content. The rights to the content may include, for example, a ‘play’ right or allowing playback of video content, a ‘display’ right for allowing display of pictures and/or documents, an ‘execute’ right for allowing execution of programs or applications, a ‘print’ right for allowing printing of documents, a ‘transfer execute’ right for allowing transmission of the RO to other devices or systems, etc. In the present example according to an embodiment of the present invention, it is assumed that a ‘play’ right for allowing playback movie content is granted.

An ‘asset’ element 202 provides an IDentification (ID) of content to which the ‘permission’ element 201 is applied. A ‘play’ element 210 represents a right applied to the content, and includes a ‘constraint’ element 220 and a ‘requirement’ element 230 as its sub elements.

The ‘constraint’ element 220 represents constraints given when the ‘permission’ element 201 is used, and the ‘requirement’ element 230 represents requirements that must be fulfilled before execution of the ‘permission’ element 201. The ‘constraint’ element 220 is described in detail in Table 1 below.

TABLE 1
Element <constraint>

| | |
|---|---|
| Element | <!ELEMENT o-ex:constraint (o-dd:count?, oma-dd:timed- |
| | count?, o-dd:datetime?, o-dd:interval?, o-dd:accumulated?, |
| | o-dd:individual?, oma-dd:system*, o-dd:discrete?)> |
| Semantics | The <constraint> element is the top most element in the |
| | constraint model. It contains the optional <count>, <timed- |
| | count>, <datetime>, <interval>, <accumulated>, |
| | <individual>, <system> and <discrete> |
| | elements. |
| | The <constraint> element contains <system> elements only |
| | when its parent <permission> element contains the <export>, |
| | <play>, or <display> element. |

A ‘discrete’ element 221 represents information corresponding to the playback time at which an advertisement required to be watched. In other words, the ‘discrete’ element 221 represents the time at which execution of a specific content being played is interrupted in order to play an advertisement. For example, after playback of a particular content has started, a device plays the content for the time represented in the ‘discrete’ element 221, and then continues playing the content after achieving the requirements included in the ‘requirement’ element 230, thereby requiring the user to watch an advertisement while playing content, using the ‘requirement’ element 230. Although 1,800 seconds are given as an example of a value of the ‘discrete’ element 221 in FIG. 2, a value in other units of time, such as hours or minutes may also be assigned. As to an operation of the DRM agent 112 with regard to the 1,800 seconds of the present example, the DRM agent 112 stops playing the content after playing the content for 1,800 seconds, and then requires the user to watch advertisement content indicated by the ‘requirement’ element 230, for a specific time. The ‘discrete’ element 221 is described in Table 2 below.

TABLE 2
Element <discrete>

| | |
|---|---|
| Element | <!ELEMENT o-dd:discrete CDATA> |
| Semantics | The <discrete> element contains a non-negative integer value that |
| | specifies the maximum value of metered usage time (in seconds, |
| | minutes, or hours) while the rights are continuously exercised over |
| | the corresponding DRM Content. |
| | The DRM Agent MUST stop execution of the associated permission |
| | after the value of the <discrete> element has elapsed. The DRM Agent |
| | MUST resume exercising of the permission after re-addressing |
| | associated requirements. After resuming the exercise of the permission, |
| | all other constrains MUST not be re-addressed because the interruption |
| | of content consumption occurs only due to <discrete> element. The |
| | permission MUST be continuously exercised as if there was no interruption. |
| | The <discrete> element is effective for the entire playing time of DRM |
| | content. For example, if <discrete> element specifies 30 minutes of |
| | continuous play time of AV content, and the <requirement> element |
| | specifies advertisement(s) assets to be enforced played, |
| | advertisement(s) will be shown every 30 minutes during normal content |
| | consumption. |
| | The <discrete> period MUST start when the associated permission |
| | is first exercised or exercised after previous <discrete> period has |
| | elapsed. |
| | The <discrete> period MUST only be metered when rendering the Content. |
| | The DRM Agent of a consuming Device without a time source MUST |
| | NOT grant access to DRM Content having permissions containing the |
| | <discrete> element. |
| | The <discrete> element MUST NOT occur as a constraint to a <print> or |
| | <export> permission. |

A ‘playout’ element 240 under the ‘requirement’ element 230 serves to require playback of an advertisement indicated by an ‘idref’ (identification reference or identification information) attribute 241 for the time included in an ‘enforcement duration’ element 242. In other words, the ‘playout’ element 240 represents identification information for an advertisement required to be played, and further represents play duration information. Operations of the ‘playout’ element 240 and the ‘enforcement duration’ element 242 are described in detail in Korean Patent Application No. 2010-82192, the entire contents of which are incorporated herein by reference.

If a ‘discrete’ element is included in an RO in this way, it indicates that advertisement enforced-watching information is included in the RO, especially indicates that the advertisement will be executed or exercised while the content is being executed.

FIG. 3 illustrates a structure of an RO according to another embodiment of the present invention. Although an RO in which a ‘discrete’ element is connected to all ‘requirement’ elements is illustrated in the embodiment described with reference to FIG. 2, FIG. 3 refers to an RO in which a ‘discrete’ element is connected to a specific ‘requirement’ element. In order for a ‘discrete’ element to be connected to a specific ‘requirement’ element, identification information for a ‘requirement’ element to which the ‘discrete’ element is to be applied should be included in the RO. Accordingly, in the embodiment of the present invention corresponding to FIG. 3, ‘reqref’ (i.e., requirement identification or requirement reference) attribute 321 and ‘ref’ (i.e., identification or reference) attribute 330 are added. The ‘reqref’ attribute 321 and the ‘ref’ attribute 330 are described in Tables 3 and 4 below, respectively.

TABLE 3
Attribute “reqref”

| | |
|---|---|
| Attribute | <!ATTLIST oma-dd:discrete oma-dd:reqref CDATA |
| | #IMPLIED> |
| Semantics | Using “regref” attribute is used for the association of |
| | individual requirement with the <discrete> element. Value of |
| | this attribute MUST correspond to the value of “ref” attribute |
| | of the associated <requirement> element. |
| | If this attribute is included, the DRM Agent MUST re-address |
| | only the linked requirements after stopping exercising of the |
| | associated permission because of <discrete> constraint. |

TABLE 4
Attribute “ref”

| | |
|---|---|
| Attribute | <!ATTLIST oma-ex:requirement oma-dd: ref CDATA |
| | #IMPLIED> |
| Semantics | The “ref” attribute is the optional identifier of the |
| | <requirement> element. It uniquely identifies each |
| | <requirement>. |
| | When present, the “ref” attribute MUST be unique within |
| | the Rights Object. |
| | This attribute is used for linking <discrete> constraint with the |
| | <requirement> element. |

Referring to FIG. 3, operations of the ‘regret’ attribute and the ‘ref’ attribute are further described as follows.

A ‘permission’ element 301 operates in the same manner as the ‘permission’ element 201 in FIG. 2, and an ‘idref’ attribute 302 provides an identifier of content to which the ‘permission’ element 301 is applied. A ‘play’ element 310 indicates rights granted to the content, and has a ‘constraint’ element 320 and a ‘requirement’ element 330 as its sub elements.

A ‘discrete’ element 321 includes a ‘reqref’ attribute as its element, which indicates that the ‘requirement’ element 330 indicated by the ‘reqref’ attribute must be executed after 1,800 seconds. Details of the ‘reqref’ attribute are specified in the ‘requirement’ element 330. Accordingly, the ‘requirement’ element 330 includes a ‘ref’ attribute as its element. The ‘ref’ attribute has an identifier of a ‘requirement’ element as its element so that the ‘requirement’ element may be uniquely identified in the RO illustrated in FIG. 3. As described above, the embodiment of the present invention corresponding to FIG. 3, unlike the embodiment corresponding to FIG. 2, provides a method for connecting the ‘discrete’ element to a specific ‘requirement’ element in an operation of the ‘discrete’ element.

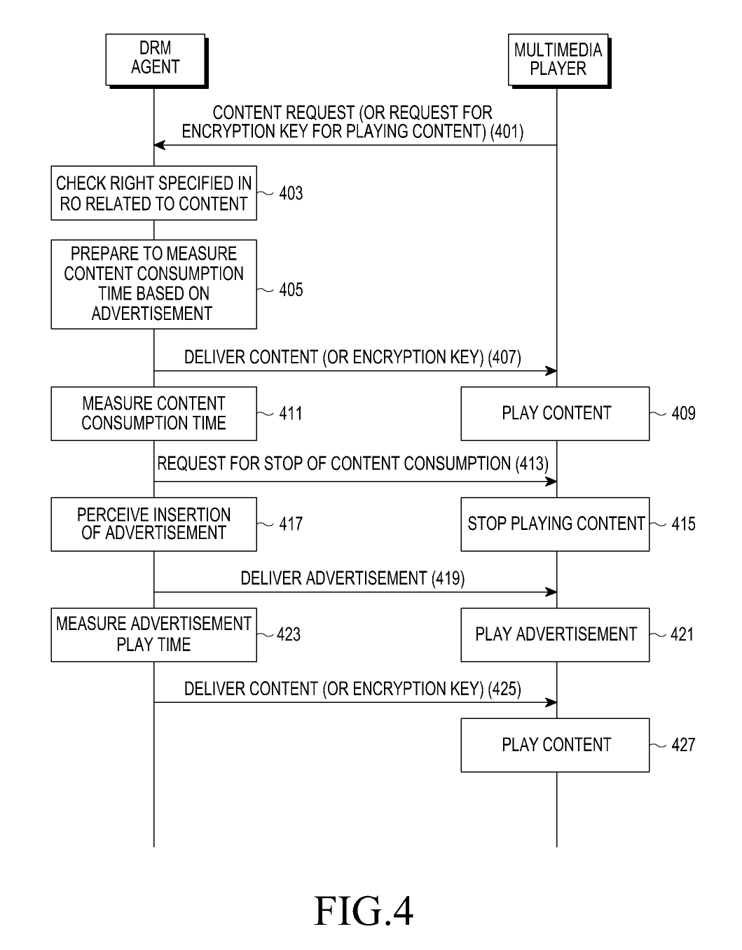

Operations of the device 110 performed when the RO created as described above is acquired, are illustrated in FIG. 4. FIG. 4 is a diagram illustrating operations performed between a multimedia player 111 and a DRM agent 112 according to an embodiment of the present invention.

Referring to FIG. 4, if the device 110 requests specific content from the content issuer 103 in the network 100, the content issuer 103 performs an authentication procedure for the device 110 in association with the rights issuer 104. If the authentication is successful, the rights issuer 104 creates an RO for specific content in association with the content issuer 103, and the created RO is delivered to the device 110 together with the specific content. The RO delivered to the device 110 may be created with a structure similar to that described with reference to Table 2 or 3 according to embodiments of the present invention.

Upon receiving an execution request for specific content from a user, the multimedia player 111 within a device 110 requests specific content or an encryption key for decrypting the specific content from the DRM agent 112 in step 401.

In step 403, the DRM agent 112 identifies an RO associated with the content requested by the multimedia player 111, and then checks the rights defined in the RO. As a result of the check, if advertisement enforced-watching information is included in the RO, the DRM agent 112 checks advertisement play time information included in the RO, and prepares to measure a content consumption time based on the advertisement play time information, in step 405.

For example, assuming that the RO created as shown in FIG. 2 corresponds to the RO associated with the content requested in step 401, the DRM agent 112 may determine that advertisement enforced-watching information is included in the RO, recognizing that the ‘discrete’ element 221 is included in the RO, and thus reset a counter for measuring content consumption time so as to count 1,800 seconds specified as advertisement play time information.

In step 407, the DRM agent 112 delivers decrypted content or an encryption key for decrypting encrypted content, to the multimedia player 111 using a message. In step 409, the multimedia player 111 executes or plays the content, thereby providing the content to the user. In step 411, the DRM agent 112 measures a content consumption time starting at the time the content is executed.

While continuously measuring the content consumption time, if it is determined that the content has been executed for a time corresponding to the advertisement play time information (i.e., a time period designated in the ‘discrete’ element 221), the DRM agent 112 requests the multimedia player 111 to stop execution/playback of the content, in step 413. In the example of FIG. 2, the DRM agent 112 requests playback of the content to stop when the content has been played for 1,800 seconds. The multimedia player 111 stops playing the content in response to the request from the DRM agent 112, and waits for the next instruction, in step 415.

After requesting playback of the content to stop, in step 417, the DRM agent 112 checks information corresponding to an advertisement required to be played and information about a play duration of the advertisement, the information being included in the RO associated with the content. In other words, the DRM agent 112 identifies an advertisement that the user must watch after the time specified in the ‘discrete’ element 221, by checking the ‘requirement’ element 330 belonging to the ‘permission’ element 201. In step 419, the DRM agent 112 delivers the advertisement to the multimedia player 111.

Upon receiving the advertisement, the multimedia player 111 plays the advertisement in step 421. In step 423, the DRM agent 112 determines that the advertisement has been played for the advertisement play duration, which is defined in the ‘enforcement duration’ element 242.

If it is determined that the advertisement has been played for the advertisement play duration, the DRM agent 112 resumes delivery of the content, playback of which was interrupted in step 415, to the multimedia player 111 in step 425, and the multimedia player 111 continues playing the content in step 427.

Although it is assumed in the above-described embodiments of the present invention that one ‘discrete’ element is defined in one content, multiple ‘discrete’ elements may be defined in the RO depending on the length of content. In this case, the DRM agent 112 and the multimedia player 111 repeat steps 405 to 427 for each respective discrete element.

In the case where multiple ‘discrete’ elements are set in one content, all advertisement play times indicated by the ‘discrete’ elements may be determined on the basis of the content play start time. For example, an advertisement play time indicated by a first ‘discrete’ element may be 1,000 seconds after the content play start time, and an advertisement play time indicated by a second ‘discrete’ element may be 2,000 seconds after the content play start time. According to an embodiment of the present invention, in counting a content execution time, the DRM agent 112 may not count the time, for which the advertisement is played in the middle of content, as a content execution time. Alternatively, the DRM agent 112 may count the advertisement play time as a part of the content execution time according to another embodiment of the present invention. Advertisements provided at individual advertisement play times may be the same or different advertisements.

Although it is assumed in the above-described embodiments of the present invention that advertisements required to be played are played for a predetermined time, the RO may be set such that a predetermined number of advertisements are played for a predetermined time. The advertisements to be played may be delivered to the device 110 together with the content, and/or acquired from the external devices at the time the advertisements are played.

As is apparent from the foregoing description, according to embodiments of the present invention, users are required to watch advertisements while enjoying multimedia services associated with the advertisements, guaranteeing advertisers authentic advertising effects. By requiring playback of advertisements for a predetermined time, the users may enjoy multimedia content associated with the advertisements at affordable prices, contributing to expanding the market for multimedia services.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for playing an advertisement in a device according to usage of a multimedia service, the method comprising:
receiving a user request to execute request specific content;
determining whether advertisement enforced-watching information is included in a rights object representing a user's consumption rights for the specific content;
executing the specific content;
stopping, if the advertisement enforced-watching information is included in the rights object the execution of the specific content according to the advertisement enforced-watching information and providing the advertisement to the user after stopping the execution of the specific content; and
resuming the stopped execution of the specific content after providing the advertisement to the user is completed.

2. The method of claim 1, wherein the specific content is initially executed from an execution start time of the specific content until an advertisement play time specified in the advertisement enforced-watching information, the execution of the specific content is stopped at the advertisement play time, and
wherein the provided advertisement corresponds to an advertisement identifier included in the advertisement enforced-watching information, and is provided to the user for advertisement play duration specified in the advertisement enforced-watching information.

3. The method of claim 2, wherein the advertisement play time is specified by a ‘discrete’ element belonging to a ‘constraint’ element belonging to a ‘permission’ element for setting a range of the consumption rights in the rights object.

4. The method of claim 3, wherein the advertisement identifier and the advertisement play duration are indicated by a ‘requirement’ element belonging to the ‘permission’ element.

5. The method of claim 4, wherein the ‘requirement’ element associated with the ‘discrete’ element is designated by a requirement identification (reqref) attribute.

6. An apparatus for playing an advertisement in a device depending on use of a multimedia service, comprising:
a multimedia player for delivering, to an agent, a user request to execute specific content, and executing the requested specific content and an associated advertisement under a control of the agent; and
the agent for determining whether advertisement enforced-watching information is included in a rights object indicating a user's consumption rights to the specific content upon receiving the execution request for the specific content, executing the specific content on the multimedia player, executing the advertisement on the multimedia player after stopping the execution of the specific content based on the advertisement enforced-watching information if the advertisement enforced-watching information is included in the rights object, and resuming the stopped execution of the specific content after execution of the advertisement is completed.

7. The apparatus of claim 6, wherein the agent initially executes the specific content from an execution start time of the specific content until an advertisement play time specified in the advertisement enforced-watching information to provide the advertisement to the user, stops the execution of the specific content at the advertisement play time, and executes the advertisement corresponding to an advertisement identifier included in the advertisement enforced-watching information on the multimedia player for an advertisement play duration specified in the advertisement enforced-watching information.

8. The apparatus of claim 7, wherein the advertisement play time is specified by a ‘discrete’ element belonging to a ‘constraint’ element belonging to a ‘permission’ element for setting a range of the consumption rights in the rights object.

9. The apparatus of claim 8, wherein the advertisement identifier and the advertisement play duration are indicated by a ‘requirement’ element belonging to the ‘permission’ element.

10. The apparatus of claim 9, wherein the ‘requirement’ element associated with the ‘discrete’ element is designated by a requirement identification (reqref) attribute.

11. A method, performed by a rights issuer issuing a user's consumption rights for a multimedia service, for providing an advertisement to be played on a device, the method comprising:
receiving a request for specific content from the device;
inserting advertisement enforced-watching information in a rights object representing a user's consumption rights to the specific content, the advertisement enforced-watching information including information corresponding to an advertisement to be played during execution of the specific content and information indicating a play time of the advertisement; and
transmitting the rights object to the device together with the specific content.

12. The method of claim 11, wherein the advertisement enforced-watching information includes information for identifying the advertisement, advertisement play time information indicating a time at which execution of the specific content is to be stopped in order to play the advertisement, and advertisement play duration information indicating a play duration of the advertisement.

13. The method of claim 12, wherein the advertisement play time is specified by a ‘discrete’ element belonging to a ‘constraint’ element belonging to a ‘permission’ element for setting a range of the consumption rights in the rights object.

14. The method of claim 13, wherein the advertisement identifier and the advertisement play duration are indicated by a ‘requirement’ element belonging to the ‘permission’ element.

15. The method of claim 14, wherein the ‘requirement’ element associated with the ‘discrete’ element is designated by a requirement identification (reqref) attribute.

16. A rights issuer for issuing a user's consumption rights to a multimedia service and playing an advertisement on a device, the rights issuer comprising:
a communication unit for receiving a request for specific content from the device; and
a processor for, upon receipt of the request for the specific content, inserting advertisement enforced-watching information in a rights object indicating a user's consumption rights to the specific content, the advertisement enforced-watching information including information corresponding to an advertisement to be played during execution of the specific content and information indicating a play time of the advertisement, and controlling the communication unit to transmit, to the device, the rights object together with the specific content.

17. The rights issuer of claim 16, wherein the advertisement enforced-watching information includes information for identifying the advertisement, advertisement play time information indicating a time at which execution of the specific content is stopped to play the advertisement, and advertisement play duration information representing play duration for the advertisement.

18. The rights issuer of claim 17, wherein the advertisement play time is specified by a ‘discrete’ element belonging to a ‘constraint’ element belonging to a ‘permission’ element for setting a range of the consumption rights in the rights object.

19. The rights issuer of claim 18, wherein the advertisement identifier and the advertisement play duration are indicated by a ‘requirement’ element belonging to the ‘permission’ element.

20. The rights issuer of claim 19, wherein the ‘requirement’ element associated with the ‘discrete’ element is designated by a requirement identification (reqref) attribute.
